(19) United States
(12) Patent Application Publication
(10) Pub. No.: US 2026/0252426 A1
(43) Pub. Date: Aug. 27, 2026

(54) Central Computing Unit for a Vehicle and Vehicle Comprising Such a Central Computing Unit as an On-Board Computing Unit

(71) Applicant: Volkswagen Aktiengesellschaft, Wolfsburg (DE)

(72) Inventor: Andreas Aal, Braunschweig (DE)

(73) Assignee: Volkswagen Aktiengesellschaft, Wolfsburg (DE)

(21) Appl. No.: 19/160,135

(22) PCT Filed: Mar. 1, 2023
(86) PCT No.: PCT/EP2023/055182

§ 371 Date: Aug. 27, 2025

(51) Int. Cl. G06F 11/07; G06F 9/50; G06F 11/20; G06F 13/42

(52) U.S. Cl. CPC G06F 11/0721; G06F 9/5094; G06F 11/2028; G06F 13/4221

(57) ABSTRACT

A central computing unit, CCU, is configured as an on-board computing unit for a vehicle, such as an automobile, to centrally control different functionalities of the vehicle. The CCU comprises a distributed computing system, DCS, a communication switch, and a power supply system. The DCS comprises a plurality of co-located, autonomous, computational entities, CEs, each of which has its own individual memory. The CEs are configured to communicate among each other by message passing via one or more communication networks to coordinate among them an assignment of computing tasks to be performed by the DCS as a whole. The communication switch comprises a plurality of mutually independent switching fabrics, each configured to variably connect a subset or each of the CEs of the DCS to one or more of a plurality of interfaces for exchanging thereover information with CCU-external communication nodes of the vehicle.

### CROSS-REFERENCE TO RELATED APPLICATIONS

This application claims priority to PCT Patent Application PCT/EP2023/055182, filed on Mar. 1, 2023 with the European Patent Office in its capacity as PCT Receiving Office. The contents of the aforesaid Patent Application are incorporated herein for all purposes.

### BACKGROUND

The disclosure relates to the field of vehicle electronics, such as, but not limited to automotive electronics. Specifically, the disclosure relates to a central computing unit (CCU) configured as an on-board computing system for a vehicle, such as an automobile, to centrally control different functionalities of the vehicle.

Typically, a modern vehicle, such as an automobile, comprises a plurality of different electronic components, including, in particular, so-called Electronic Control Units (ECUs) which are interconnected by means of one or more communication links or whole networks, such as bus systems, e. g., of the well-known CAN or LIN type. Also, Ethernet-based networks are becoming more and more relevant in that context. It is noted that while generally, in the field of automotive technology, the acronym “ECU” is also frequently used to refer specifically to an engine control unit, this acronym is used herein in a broader sense to refer to any electronic controller or control unit for a vehicle, wherein an engine control unit is just one possible example of such a control unit.

Many ECUs are in fact embedded systems comprising hardware, such as a processing platform and related software running on the processing platform. Accordingly, such an ECU forms an embedded system and when multiple ECUs are interconnected via a communication network, such network can be designated as a distributed embedded system (network). While such an “embedded” set-up is particularly useful in terms of its capability to provide real-time processing and an optimized fit of the software of a given ECU to its respective processing platform, it is typically difficult to extend or scale such embedded systems or to add new functionality.

### SUMMARY

A need exists to provide an improved computing system for a vehicle such as an automobile.

The need is addressed by the subject matter of the independent claim(s). Embodiments of the invention are described in the dependent claims, the following description, and the drawings.

### BRIEF DESCRIPTION OF THE DRAWINGS

FIG. 1A illustrates, according to embodiments of the present solution, a first block diagram illustrating functional building blocks of an example CCU and a related high-level communication structure for communication within the CCU and with CCU-external nodes;

FIG. 1B illustrates in more detail some of the functional building blocks of the CCU of FIG. 1A;

FIG. 2A illustrates, according to embodiments of the present solution, a first view of a second block diagram showing more details of the functional building blocks of the CCU of FIG. 1, with a focus on the redundant set-up of power supply and power supply coordination, control coordination, and computing coordination within the CCU;

FIG. 2B illustrates a second view of the block diagram of FIG. 2A, however now with a focus on abnormality detection in the power supply domain;

FIG. 2C illustrates an example redundancy concept with multiple instantiations per master CE and/or per associated switching fabric;

FIG. 3 illustrates a classical strictly hierarchical communication scheme from the prior art, according to the PCI Express communication technology;

FIG. 4A illustrates, according to embodiments of the present solution, an example adapted communication scheme using the PCI Express technology as a basis;

FIG. 4B illustrates, according to embodiments of the present solution, various example communication links being enabled by the adapted communication hierarchy of FIG. 4;

FIG. 5 illustrates, according to embodiments of the present solution, a third block diagram showing details of an exemplary CCU, e.g., the CCU of FIG. 1, particularly of its communication switch;

FIG. 6 illustrates, according to embodiments of the present solution, an example housing concept of an exemplary CCU, e.g., the CCU of FIG. 1; and

FIG. 7 illustrates schematically an example vehicle (specifically an automobile) being equipped with a CCU and various different suitable locations for placing the CCU within the vehicle.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments are directed to a central computing unit, CCU, configured as an on-board computing unit for a vehicle, such as an automobile, to centrally control different functionalities of the vehicle. Such functionalities may particularly include functionalities that are functionally independent from each other.

The CCU comprises (i) a distributed computing system, DCS, (ii) a communication switch, and (iii) a power supply system.

The distributed computing system comprises a plurality of co-located (e.g., in a same housing, such as a closed housing or an open housing, e.g., a rack), autonomous computational entities, CEs, each of which has its own individual memory. The CEs are configured to communicate among each other by message passing via one or more communication networks, such as high-speed communication networks, e.g., of the on PCIExpress or Ethernet type, to coordinate among them an assignment of computing tasks to be performed by the DCS as a whole. Particularly, in case of multiple communication networks, these networks may be coupled in such a way as to enable passing of a message between a sending CE and a receiving CE over a communication link that involves two or more of the multiple networks. For example, a given message may be sent from a sending CE in a PCIExpress-format over one or more first communication paths in a PCIExpress network to a gateway that then converts the message into an Ethernet-format and forwards the converted message over one or more second communication paths in an Ethernet-network to the receiving CE.

The communication switch comprises a plurality of mutually independent (i.e., at least functionally independent) switching fabrics, each configured to variably connect a subset or each of the CES of the DCS to one or more of a plurality of interfaces for exchanging thereover information with CCU-external communication nodes of the vehicle, such as network endpoints, e.g., actuators or sensors, or intermediate network nodes, e. g., hubs, for connecting multiple other network nodes.

The power supply system comprises a plurality of power supply sub-systems for simultaneous operation, each of which is individually and independently from each other capable of powering the DCS and at least two, or for example all, of the switching fabrics. Herein, “powering” means particularly delivering power to the entity to be powered and may optionally further comprise generating the power in the first place and/or converting it to a suitable power kind or level, e.g., by DC/DC, AC/DC, or DC/AC conversion, or a conversion of a time-dependency of a power signal (signal shaping).

The term “computational entity”, CE, (and variations thereof), as used herein, refers to an autonomous computing unit which is capable of performing computing tasks on its own and which comprises for doing so at least one own processor and at least one own associated memory. Particularly, each CE may be embodied separately from all other CEs. For example, it may be embodied in one or more circuits, such as in an integrated circuit (e.g., as a system-on-chip (SOC), a system-in-package (SIP), multi-chip module (MCM), or chiplet) or in a chipset.

The term “distributed computing system”, DCS, (and variations thereof), as used herein, refers particularly to a computing system comprising multiple networked computational entities, which communicate and coordinate their actions by passing messages to one another, so that the computational entities interact with one another in order to achieve a common goal. Particularly, the set of individual CEs of the DCS may be configured to perform parallel task processing such that the CEs of the set simultaneously perform a set of similar or different computing tasks, e.g., such that each CE individually performs a true subset of the set of computing tasks to be performed by the DCS as a whole, wherein the computing tasks performed by different CEs may be different.

The term “switching fabric” (and variations thereof), as used herein, refers particularly to hardware for variably connecting multiple different nodes of a network, such as nodes of a computer network, to exchange data therebetween.

The term “communication switch” (and variations thereof), as used herein, comprises at least two switching fabrics and is configured to use the switching fabrics, alternatively or simultaneously, to variably connect multiple different nodes of a network, such as nodes of a computer network, to exchange data therebetween. A communication switch may particularly include, without limitation, one or more PCI Express (PCIe) switches and/or Compute Express Links (CXL) as switching fabrics.

The term “switching” (and variations thereof), as used herein (including in the terms “switching fabric” and “communication switch”), refers generally to variably connecting different nodes of a network to exchange data therebetween, and unless explicitly specified otherwise herein in a given context, is not limited to any specific connection technology such as circuit switching or packet switching or any specific communication technology or protocol, such as Ethernet, PCIe, and the like.

The terms “first”, “second”, “third” and the like in the description and in the claims, are used for distinguishing between similar elements and not necessarily for describing a sequential or chronological order. It is to be understood that the terms so used are interchangeable under appropriate circumstances and that the embodiments of the present solution described herein are capable of operation in other sequences than described or illustrated herein.

Unless the context requires otherwise, where the term “comprising” or “including” or a variation thereof, such as “comprises” or “comprise” or “include”, is used in the present description and claims, it does not exclude other elements or steps and are to be construed in an open, inclusive sense, that is, as “including but not limited to”.

Where an indefinite or definite article is used when referring to a singular noun e.g., “a” or “an”, “the”, this includes a plural of that noun unless something else is specifically stated.

Appearances of the phrases “in some embodiments”, “in one embodiment” or “in an embodiment”, if any, in the description are not necessarily all referring to the same embodiment. Furthermore, the particular features, structures, or characteristics may be combined in any suitable manner in one or more embodiments.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Many of the functional units, building blocks, or systems described in this specification have been labelled as systems or units, in order to more particularly emphasize their implementation independence. For example, a system may be implemented as a hardware circuit comprising custom VLSI circuits or gate arrays, off-the-shelf semiconductors such as logic chips, transistors, or other discrete components. A system or functional unit may also be implemented in programmable hardware means such as field programmable gate arrays, programmable array logic, programmable logic means or the like.

Functional units, building blocks, and systems may also be implemented in software for execution by various types of processors or in mixed hardware/software implementations. An identified device of executable code may, for instance, comprise one or more physical or logical blocks of computer instructions which may, for instance, be organized as an object, procedure, or function. Nevertheless, the executables of an identified device need not be physically located together but may comprise disparate instructions stored in different locations which, when joined logically together, comprise the device and achieve the stated purpose for the device. Indeed, a device of executable code could be a single instruction, or many instructions, and may even be distributed over several different code segments, among different programs, and across several memory means. Similarly, operational data may be identified and illustrated herein within devices and may be embodied in any suitable form and organized within any suitable type of data structure. The operational data may be collected as a single data set or may be distributed over different locations including over different storage means, and may exist, at least partially, merely as electronic signals on a system or network.

A CCU according to the present solution can provide a number of benefits, including one or more of the following:
(i) Easy scalability of the computing power (further CEs may be added or CES may be removed, and computing tasks can be optimally distributed among the available CEs).
(ii) High degree of efficiency to perform many different kinds of computing tasks. For example, one or more CEs may specially adapted to perform certain specific tasks, such as machine learning, image rendering, real-time processing, general purpose computing etc. all with the option for sequential as well as parallel processing so that computing tasks can be selectively performed by one or more suitably adapted specialized CEs within the DCS. Furthermore, the total amount of computing power being allocated by the DCS to a particular computing task may be variably adapted “on the fly”;
(iii) High degree of flexibility to perform many different and even varying kinds of computing tasks. In the conventional “world” of automotive ECUs, each ECUs is typically designed to meet a small and limited number of specified fixed and dedicated concrete functions being realized by the underlying ECU hardware and generally proprietary software especially composed for that hardware. Both hardware and software are intended to be almost unchanged until the vehicle reaches its end-of-life status potentially except for some minor software-updates related to bug-fixes or very small functional extensions. The present solution vercomes these limitations and enables not only a flexible allocation of computing tasks among the set of CEs but also an extension or alteration of the computing tasks and hence functionalities the CCU can support. Particularly, software defining such functionalities may be easily updated or upgraded (e. g., “over the air”, OTA) to enable such extension or alteration and even new software may be easily added. Such changes on the software-level may even be performed very frequently, whenever needed. Furthermore, by adding, replacing, or removing individual CEs or groups of CEs, even the underlying computing hardware may be easily adjusted to a changed or new set of functionalities to be supported.
(iv) High performance and power efficiency: due to the co-location, the communication links between the CEs can be kept short, thus enabling high-speed communication among them with little power loss and high signal quality. Accordingly, a high degree of performance, power efficiency and reliability of the DCS as a whole can be achieved.
(v) High reliability, due to a high degree of flexible redundancy both in regard to a flexible allocation of computing tasks to selected CEs and a redundant power supply.

In some embodiments of the CCU are described, which can be arbitrarily combined with each other, unless such combination is explicitly excluded or technically impossible.

In some embodiments, the plurality of CEs comprises a group of two or more master CES, which are configured to work redundantly in such a way that they synchronously perform identical computing tasks or data path coordination tasks to enable a proper functioning of the CCU for as long as at least one of the master CES is properly working. Due to the redundancy, a proper functioning of the CCU may be maintained, even when all but one of the master CEs fail. Specifically, this may even be achieved without interruption when one or more of the master CEs fail (with the exception of at least one).

In some embodiments, the plurality of CEs further comprises one or more slave CEs and each of the master CEs comprises a resource coordination functionality being configured to: (i) define an assignment of the computing tasks variably among the CEs in a set comprising one or more, particularly all, of the slave CES, and optionally the set of all master CEs, and (ii) to communicate such assignment by message passing via the communication network to at least each CE which has to perform, according to this defined assignment, one or more selected computing task. Accordingly, while the master CEs may selectively assign computing tasks to all or a subset of the slave CEs of the DCS, the master CEs will not selectively assign computing tasks to each other. Rather, if computing tasks are assigned to a master CE, then such an assignment will only be made such as to cause all master CES collectively to synchronously perform such (identical) assigned computing task. In this way, the redundancy provided by the set of master CEs is maintained while the possibility to selectively assign computing tasks among the slave CEs (and optionally also the set of master CEs as a whole) provides a high level of flexibility and enables an optimized allocation of computing tasks within the DCS.

Specifically, in some of embodiments, the respective resource coordination functionality of one or more of the master CEs is further configured to (i) receive a periodic reporting of currently active computing tasks being performed by one or more of the slave CEs, and (ii) to define said assignment of computing tasks based on the reporting. This supports a definition of an optimized assignment of current or upcoming computing tasks to be performed by the DCS, because such assignment can thus be defined in view of actually available computing power and capacities of the individual slave CEs or the set of slave CEs as a whole. This may particularly be beneficial to avoid bottleneck situations, for example in the case of rather limited capacities of specialized CEs with within the set of slave CEs. Such specialized CEs may be, for example, graphics processing units (GPU) or a slave CEs being specifically designed and/or configured to run algorithms in the field of artificial intelligence, e.g., deep learning algorithms and the like.

In some embodiments, the respective resource coordination functionality of one or more of the master CEs is further configured to define said assignment of computing tasks based on an amount of energy that is currently made available by the power supply system to the CEs and/or to the switching fabrics. In this way an optimized assignment of computing tasks can even be achieved in situations where due to power shortage less than 100% of the power needed to have all CEs perform at maximum speed is available. Specifically, such a situation may occur, if the remaining available power level is insufficient for simultaneously powering all CEs or for supporting all simultaneously ongoing or imminent computing tasks. The resource coordination functionality may be configured to define in such a case the assignment of computing tasks in such a way that selected ones of the computing tasks are abandoned, paused, or moved to another CE (particularly so that the previously tasked CE can be shut down or put to a low-energy idle or hibernation mode or the like, to reduce the current power consumption of the DCS.

In some embodiments, the respective 1 resource coordination functionality is further configured to define said assignment of computing tasks such that a computing task is assigned to different slave CES in parallel, i.e., redundantly. A total result of the computing tasks may then be derived from the individual results generated by the involved slave CEs by a voting process based on one or more defined voting criteria, e.g., based on processor core load and/or a power consumption of the slave CES as voting criteria. This increases the safety level through parallel execution algorithms rather through costly redundancy of hardware as compared to classical embedded systems (ECUs).

In some embodiments, the CCU comprises a central fault management functionality which is configured to: (i) select from the group of two or more master CEs one particular master CE as a current priority master CE; (ii) execute the computing tasks by the CEs in the set of CEs according to the assignment defined by the current priority master CE, while discarding the assignments defined by all other master CEs; and (iii) if a malfunctioning of the current priority master CE or of a switching fabric being associated therewith is detected, select another one of the master CEs, which is determined to work properly, as the new priority master CE such that the assignment defined by the new priority master CE replaces the assignment defined by the malfunctioning current master CE. The central fault management functionality may particularly be implemented in multiple redundant, particularly separate and/or mutually independent, instantiations. In some of these embodiments, selecting the current priority master CE comprises ascertaining ab initio that the particular master CE to be selected as the priority master CE is working properly. If this is not the case, another master CE is selected ab initio as priority master CE, provided it is found to be working properly. In this way, very high levels of overall reliability and/or availability of the CCU can be provided ab initio.

In some embodiments, the central fault management functionality is further configured to detect a malfunctioning of the DCS or the communication switch based on monitoring information representing measurements of one or more of: (i) a malfunctioning detected by an individual fault management functionality of a subsystem (such as a module, e.g., computing module, an individual CE, or a switching fabric), or individual component (such as a semiconductor device) of the CCU; (ii) an electric voltage, an electric current, a clock signal, and/or a data rate in one or more power lines or signal paths running between the power supply system and the DCS (such as signal paths in one or more of the switching fabrics); (iii) a malfunctioning detected by the power supply system. In this way, fault (malfunctioning) detection can be applied both selectively, e.g., at the most critical places in the CCU, and distributed across multiple levels of the CCU, be it on the level of the overall CCU system, on the level of individual modules or functional units of the CCU, or even more specifically on the level of individual components or even signal paths or power lines. Specifically, the fault detection can be used to trigger an (active) use of redundancy build into the CCU, when a failure somewhere in the CCU is detected. Accordingly, a high level of fault detection may be achieved to support the overall reliability and cyber security of the CCU as a whole and of its individual subunits.

In some embodiments, the central fault management functionality is further configured to: (i) classify, according to a predetermined classification scheme, any detected malfunctioning to generate corresponding classification information representing one or more fault classes of the classification scheme being assigned to the malfunctioning per the classifying; and (ii) to react to any detected malfunctioning based on the one or more fault classes being assigned to such malfunctioning. Thus, the CCU can react, by means of the central fault management functionality, selectively to any detected malfunctioning. Particularly, such reaction may be defined either a priori, e.g., according to a fault reaction plan being defined as a function of one or more of the fault classes, or even ad hoc or otherwise variably, e.g., based on a trained machine-learning-based algorithm taking the one or more fault classes being assigned to a detected malfunctioning as input value(s) and providing an output specifying an adequate reaction, e.g., one or more countermeasures being suitable to mitigate or even avoid adverse consequences arising from the malfunctioning.

In some embodiments, the central fault management functionality is further configured to: (i) monitor a time-evolution of one or more differences relating to signal propagation and/or signal integrity between two equal signals propagating simultaneously through two or more synchronously operating ones of the switching fabrics; and (ii) to determine, based on the monitored time-evolution of the differences, at least one of (ii-1) an aging indicator indicating an age or an aging progress of at least one of the switching fabrics and (ii-2) an indicator for a cyber-attack against the CCU; and (iii) when a potentially critical aging condition or a cyber threat is detected based on the one or more indicators, initiate one or more counter measures.

Since instructions are executed synchronously in the switching fabrics, it is possible to define and evaluate monitoring parameters that monitor even small differences (no fault, error, failure) with regard to signal integrity and runtime behavior between the switching fabrics. These differences are inherent, because in practice, it is virtually impossible for the switching fabrics to be a 100% identical. Rather, each CCU including its switching fabrics is subject to many manufacturing tolerances, which are even present in today's most sophisticated manufacturing processes, such as semiconductor manufacturing and packaging processes. In view of its high complexity with typically millions or even billions of gates in an integrated circuit, a CCU may thus be considered a Physically Unclonable Function (PUF). If the monitoring yields, that the monitored values change over time, this can be interpreted particularly as either an aging indicator or, depending on the threshold, as an indication of an activated cyber threat, such as a hardware trojan. Consequently, if such a cyber threat or a potentially critical aging condition is detected based on the one or more indicators, counter measures such as risk mitigation steps may be initiated, like issuing a related warning or even a controlled shut-down of the CCU or part thereof, like in a failure scenario or safety management scenario as described herein.

In some embodiments, each of the master CEs has a single exclusively associated one of the switching fabrics being configured to connect the respective master CE to one or more of the plurality of interfaces for exchanging thereover information with said CCU-external communication nodes. Furthermore, said selecting of one particular master CE as the current priority master CE comprises selecting from the plurality of switching fabrics that switching fabric which is associated with the current priority master CE as a single currently valid switching fabric for communicating data to be further processed, e.g., by the CEs or the nodes, while data being communicated via any one of the other switching fabrics is discarded. In this way, a full redundancy of the master CEs including their respective switching fabrics can be maintained, particularly in the sense of a “hot standby” where all master CEs and switching fabrics are in fact operating simultaneously such that the function of the current priority master CE and its associated currently valid switching fabric may be immediately taken over by another master CE and its associated (other) switching fabric simply by adapting the assignments as master CE and currently valid switching fabric, respectively, accordingly. Such adaptation may be made instantly, i.e., without significant delay, such that the CCU as a whole can remain available to perform its tasks even if a master CE or its associated switching fabric become subject of a failure.

In some of these embodiments, the single exclusively associated one of the switching fabrics may be variably selectable, e.g., by a software and/or hardware switch, e.g., by means of FPGA-(re) programming, but in such a way that at any point in time there is only a single (currently) exclusively associated one of the switching fabrics for each master CE. This approach may be particularly useful, if a previously associated switching fabrics becomes malfunctioning or fails but the associated master CE does not. Accordingly, by updating the association, the master CE may continue to operate, albeit with another, newly associated one of the switching fabrics.

In some embodiments, each of one or more of the master CEs has two or more of the switching fabrics being exclusively associated with this master CE and configured to variably connect this master CE to one or more of the plurality of interfaces for exchanging thereover information with said CCU-external communication nodes. In this way a further level of redundancy can be provided in that the respective master CE may continue to perform its duty even if one or more but one of its associated switching fabrics malfunction or fail.

In some embodiments, each of one or more of the switching fabrics has two or more of the master CEs being exclusively associated with this switching fabric, the switching fabric being configured to variably connect each of these associated master CEs to one or more of the plurality of interfaces for exchanging thereover information with said CCU-external communication nodes. In this way a further level of redundancy can be provided in that the respective switching fabric may continue to perform its duty even if one or more but one of its associated master CEs malfunction or fail.

Particularly, said additional levels of redundancy for the master CEs and the switching fabrics may even be combined so that two or more master CEs are exclusively associated with two or more of the switching fabrics.

In some embodiments, the CCU further comprises a safety management functionality which is configured to determine a selective allocation of a remaining power which the power supply system can still make available among the computing tasks and/or different components of the CCU, when it is determined that the power the power management system can currently provide is insufficient to properly support all ongoing or imminent already scheduled computing tasks. This safety approach is particularly useful in emergency situations, such as in case of a partial system failure, e.g., after a car accident or a sudden defect of critical subsystem or component of the CCU, or if external effects (such as very cold temperatures reducing a power supply capability of batteries) have an adverse effect on the balance of power needed in the CCU versus power available. For example, in case of a detected car accident, power needed to move or guide the car to a save place, e. g., at the roadside or a near parking lot, is more important than continuing a supply of power to mere convenience functionality such as air conditioning or entertainment functionalities. Accordingly, supplying remaining power to computing tasks needed to move the car to the safe place will then typically take priority over providing power to the convenience functions.

Specifically, in some embodiments, the safety management functionality is configured to determine the selective allocation of the remaining power based on the classification information. In this way, previously defined optimized power allocation schemes can be used which define a selective power allocation based on scenarios relating to one or more of the classes. This enables a fast, optimized, and predetermined reaction of the safety management functionality and thus the CCU as such, to safety-relevant scenarios, should they occur.

In some embodiments, the CCU (i) is further configured to perform one or more predefined emergency functionalities, when its proper functioning is impaired or disrupted (e.g., if all master CEs fail concurrently), and (ii) comprises an emergency power source being configured to power at least one defined emergency functionality of the CCU, when the power supply system fails to provide sufficient power to support this at least one emergency functionality. An impairment or disruption of the proper functioning of the CCU may particularly be determined, when the fault management system detects any malfunction or, more specifically, only when the fault management system detects a malfunction meeting one or more defined criteria, such as being from a set of predefined critical malfunctions. An example of an emergency functionality might be initiating a switching-off of potentially dangerous components of a vehicle or initiating an emergency call (such as a call to “110” or “112” in Germany or to “911” in the USA).

In some embodiments, one of the switching fabrics (e.g. a third switching fabric that is not powered redundantly by the above-mentioned power supply sub-systems) is configured as an emergency switching fabric such that: (i) the emergency power source is configured to power this emergency switching fabric when the power supply system fails to provide sufficient power to support the emergency functionalities; and (ii) the emergency switching fabric is configured to variably connect solely CEs in a true subset of the CEs, the subset including at least one slave CE (e.g. exclusively one or more of the slave CEs), to one or more of a plurality of interfaces for exchanging thereover information with CCU-external communication nodes, e.g. of the vehicle. In this way, in case the proper functioning of the CCU is impaired or disrupted (emergency), an emergency operation mode of the CCU may still be available in many cases, where powered by the emergency power source selected emergency functionalities, such as stopping a vehicle in a controlled manner, e. g., pulling it to the side of the street or road and bringing it to a halt, initiating warning lights, etc. are available, while any functionalities which would in normal operation be handled by one or more of the other CES outside the subset of CEs will automatically terminate due to lack of powering and thus without a need to involving the resource control functionality for that purpose. This also helps to optimize the use of the remaining energy budget of the emergency power source by avoiding power consumption by less important functionalities assigned to the CEs outside the subset. The CCU may particularly be configured such that the emergency switching fabric is managed by at least one of the master CEs. Herein, “managing” a switching fabric may particularly comprise one or more of (i) activating and/or deactivating the switching fabric, (ii) selecting (from a set of multiple available modes) or otherwise defining a specific mode of operation of the switching fabric and maintaining or transferring the switching fabric in such selected/defined mode. A given mode of operation may particularly define a related specific communication path for transferring information to be communicated via the switching fabric between an input thereof to one or more selected outputs thereof.

In some embodiments, one or more of (i) the central fault management functionality and (ii) the safety management functionality are implemented redundantly by means of a plurality of respective mutually independent instantiations thereof, wherein each of the master CEs has an associated different one of the instantiations (of each of the aforementioned functionalities). In this way, a further hardening of the CCU against failures can be achieved.

In some embodiments, at least one of the switching fabrics further comprises for at least one of the interfaces an associated bridge for converting information to be communicated via the respective interface between different communication technologies, e.g., communication standards or protocols, such as Ethernet, PCI Express (PCIe), CAN, or LIN. This allows for hybrid systems involving multiple communication technologies within the CCU as such, and further for (typically wireless) communication with CCU-external communication nodes, such as sensors or actuators of the vehicle or even vehicle-external nodes, such as traffic control infrastructure or other vehicles.

In some embodiments, each of the switching fabrics is designed as a PCI Express switching fabric. Among the benefits which may be achieved in this way are a high data rate, a high reliability due to point-to-point connections (as opposed to bus-type connections), and a hot-plugin functionality which is particularly useful in connection with exchanging or replacing modules, such as computing modules (each having one or more CEs) of the CCU in a quick and easy manner. Moreover, the PCI Express technology allows for a separation of concerns using particularly so-called non-transparent bridges (“NTB”): Specifically, in some embodiments, at least one of the CEs comprises multiple PCI Express root ports, each being communicatively connected to at least one of the switching fabrics being designed as a PCI Express switching fabric. Particularly, one or more of the PCI Express switching fabrics may comprise a PCI Express interface being operable as a PCI Express non-transparent bridge (“NTB”) to enable a communication path between a first CE being communicatively connected with the PCI Express non-transparent bridge via an associated PCI Express root port of such CE and a second CE being communicatively connected to that PCI Express switching fabric. Accordingly, these embodiments allow for a data transfer between endpoints in different PCIe hierarchies.

In the context of PCI Express (PCIe) technology, from a functional perspective, a non-transparent bridge (NTB) and a transparent bridge (TB) have in common that both provide a communication path between independent PCIe hierarchies. However, in contrast to TBs, NTBs provide by their non-transparency effect that network devices of the NTB's downstream side are non-transparent (non-visible) for devices from the upstream side. This allows the master CEs and corresponding switching fabric-related devices (downstream side) to act and appear as one intelligent control entity. The communication path between hierarchies/busses on the downstream side enables a direct data transfer to the bus's upstream side “without” the master CEs being involved as intermediate stations (the data flow path does not need to run through the master CE at first. Therefore, similar to a point-to-point bridge mechanism, transactions can be forwarded based on NTBs barrier free across buses, while corresponding resources remain hidden.

Overall, these embodiments allow for a greater flexibility in system design of the CCU and during its operation. The latter particularly because data may now be exchanged even between endpoints of different PCI Express hierarchies and thus an efficient sharing of workload between different CEs belonging to different PCI Express hierarchies is enabled.

In some embodiments, the CCU is further configured to perform a boot process or reset process during which the communication nodes connected to the at least one PCI Express switching fabric are fully enumerated such that upon completion of the process, these communication nodes have an assigned identification code by which they can be distinguished by other communication nodes and/or the PCI Express switching fabric itself. In this way, the possibility to easily make this distinction is enabled ab initio, i.e., already when the CCU is booting or recovers after a reset such that the enumeration is already fully available once the CCU is (again) in full operating mode.

In some embodiments, the CCU is configured to operate two or more, particularly all, of the CEs according to a same shared clock. This is particularly useful in view of a dynamic allocation of ongoing or imminent computing tasks among the CEs, because no further—particularly time, power, or space consuming—synchronization measures or pipelines etc. need be used to enable a swift dynamic allocation of computing tasks. Specifically, the master CEs may for example be operated according to a same shared clock in order to achieve a high degree of synchronicity.

In some embodiments, each of the power supply sub-systems individually comprises at least one own power source and a power control arrangement for controlling a supply of power from the at least one own power source to all of the CEs and switching fabrics or to at least a subset thereof being associated with the respective power supply sub-system. Accordingly, each power supply sub-system thus achieves a high degree of independence, particularly so that it can power the CCU or at least substantial parts thereof even in cases, where due to failure of the power supply sub-systems, it remains as a sole (still) functioning power supply sub-system. The overall reliability of the CCU is thus further increased.

In some embodiments, each of the power control arrangement is configured to control the supply of power from the at least one own power source to different subsystems (e.g., CEs or switching fabrics) or components (e. g., semiconductor chips, such as systems-on-chip, SOC) of the CCU selectively as a function of an amount of energy the at least one own power source is currently capable of delivering.

In some embodiments, the CCU further comprises a supply controller being configured: (i) to determine, based on state information representing for each power supply sub-system its current condition, a distribution of individual power supply contributions to be supplied by the various power supply sub-systems such that these contributions collectively meet a current target power level of the CCU; and (ii) to control the power supply sub-systems to cause each of them to supply power according to its determined respective individual power supply contribution.

Specifically, the supply controller may be configured to control the power control arrangements of two or more, particularly of all, of the power supply sub-systems so as to cause them to have their respective own power source supply the determined respective individual power supply contribution. The controller may particularly be configured to determine the distribution based on a voting-scheme for selecting a particular power supply sub-system as a single power source or on a load sharing scheme according to which two of more of the power supply sub-system are required to simultaneously supply power, each according to its individual power supply contribution defined by the distribution.

In some embodiments, the ccu comprises a security functionality being configured to apply one or more of: (i) encryption or obfuscation to data to be communicated via the switching fabrics; (ii) authentication of at least one device being connected, directly or indirectly, as a communication node to one or more of the switching fabrics; and (iii) security off-loading of security tasks related to the security functionality to specialized security components of the CCU other than the CEs. While options (i) and (ii) serve particularly to increase the overall security of the CCU, e.g., provide protection against unauthorized access to the data being communicated or computed in the CCU, option (iii) is mainly directed to efficiency and speed, because security tasks which would otherwise consume computing power of one or more CEs can be shifted to specialized security components. As specialized devices, the security components may be particularly optimized, e.g., based on specific hardware, to perform related security tasks more efficiently than the CES (which generally need to be able to perform a broader variety of different computing tasks) so that even the overall efficiency of the CCU may be increased. In addition, these specialized security components may have special, e.g., hardware-based, security features that are not available at the CEs.

In some embodiments, the CCU is configured to host the CEs in co-location within a same shared housing structure. Furthermore, one or more of the CEs are incorporated, individually or together with one or more other CES, in a respective replaceable module, also referred to as ‘assembly’, that is individually insertable and extractable from the housing structure. This has the benefit, that the CCU is not only “central” from an abstract computing point of view, but also physically. This is to be seen in contrast to today's classical approach, where an abundance of different controllers (ECUs) is physically distributed across the vehicle, each ECU being specialized to perform only selected computing tasks pertaining to a particular functionality of the vehicle. The co-location approach according to these embodiments is particularly useful in view of original installation, maintenance, repairing, updating, and upgrading of the CCU, because it allows for a spatially consolidated and modular provision of and access to subsystems, particularly the modules, of the CCU. If, for example, more computing power than initially available is needed in order to enable a further computing-intensive functionality the owner of the vehicle has only recently acquired, i.e., after delivery of the vehicle, one or more relevant computing modules can be easily replaced by more powerful modules (e. g., with more or more advances CEs therein). Similarly, malfunctioning modules can be easily replaced due to the centralized and modular approach. Furthermore, providing a shared housing structure helps to reduced weight, reduce connector variances, enable a central software updating (rather than locally distributed per ECU). Moreover, the whole vehicle fabrication process can be simplified due to the integration of one pre-configured modular CCU instead of several ECUs at different locations within the vehicle.

In some embodiments, two or more, particularly all, of the master CEs are incorporated in a same one of the modules. Such a module may, for example, be designated as “main module” and is particularly useful, if maximizing the number of other modules within the CCU in a given special setting needs to be optimized.

In some embodiments, the CCU further comprises a service module configured to be also hosted in the housing structure, the service module comprising at least one, particularly all, of the power supply sub-systems, the switching fabrics, and the interfaces.

For example, a spatial set-up of a CCU may be defined such, that there is one main module (comprising two or more master CEs) and an additional number N of other computing modules (“extension modules”), each comprising one or more slave CEs, so that the overall arrangement of the modules results in a compact form factor. A further module may, for example be the service module. Specifically, in some embodiments, the service module is designed as a replaceable module which is individually insertable and extractable from the housing structure. Accordingly, in this case, also the service module can be easily replaced, extracted for repair or maintenance, or upgraded by replacing it with a more advanced version.

In some embodiments, the housing structure comprises a rack having two or more compartments, each compartment for hosting a respective one of the modules. For example, the compartments of the rack may be arranged in two rows and three columns (or vice versa) in the case of N=4, i.e., if there are six modules in total (the main module, the service module, and N=4 extension modules).

In some embodiments, the housing structure further comprises a connection device, such as a backplane, configured to: (i) provide one or more physical communication paths of at least one of said communication networks for exchanging messages among the CEs being co-located in the housing structure and each being communicatively connected to the connection device as a respective communication node of said at least one communication network; and/or (ii) connect at least one of the CES being co-located in the housing structure to the power supply system to enable a power supply of said at least one CE. This approach is particularly useful in connection with the concept of simple replaceability of the modules, as it enables a plug-and-play approach, where all necessary connections of a replaceable module can be implemented as detachable connections, using e.g., suitable connectors between the module and the connection device, such as connectors of the plug and socket type.

In some embodiments, the connection device is a passive connection device comprising exclusively components being incapable of power gain.

The term “passive connection device”, as used herein, may particularly refer to a circuit board, such as a printed circuit board (PCB), comprising a plurality of connectors, particularly for exchanging information-carrying signals, such as electrical or optical signals being modulated based on the information to be carried, and which circuit board comprises, in terms of its components, exclusively passive components, i.e., components being incapable of power gain. For example, and without limitation, connectors, electrical or optical traces, purely optical signal splitters and/or combiners, connectors, resistors, capacitances are typically passive components, while transistors or integrated circuits, e.g., CPUs or systems-on-chip (SOC), are active devices. Specifically, the connection device may even be free of any active or passive components (such as components to be attached to a PCB, e.g., via soldering, like SMD or PCB-embedded components) other than electrical or optical traces, e.g., on a printed circuit board, and connectors so as to enable a (particularly substantially transparent) exchange of electrical or optical signals or power via the connection device. Such a design is particularly beneficial in relation to a very high failure safety, since there are no components which have a typical (too short) limited average lifetime and/or a higher susceptibility to failures. There is then also no need for cooling any components.

Using a passive connection device may deliver various benefits, including a high level of reliability, because there are no active components which might fail over time. Accordingly, the likelihood that the connection device needs to be repaired or replaced, which would typically involve significant and costly efforts when the CCU is installed in a given vehicle, can be kept very low, at least on average, because generally, passive components tend to fail much less frequently than active components.

A second aspect of the present solution is directed to a vehicle, such as an automobile, comprising the CCU of the first aspect, for example but without limitation according to one or more of its embodiments as described herein, as an on-board computing unit for centrally controlling different functionalities of the vehicle.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

In the embodiments described herein, the described components of the embodiments each represent individual features that are to be considered independent of one another, in the combination as shown or described, and in combinations other than shown or described. In addition, the described embodiments can also be supplemented by features other than those described.

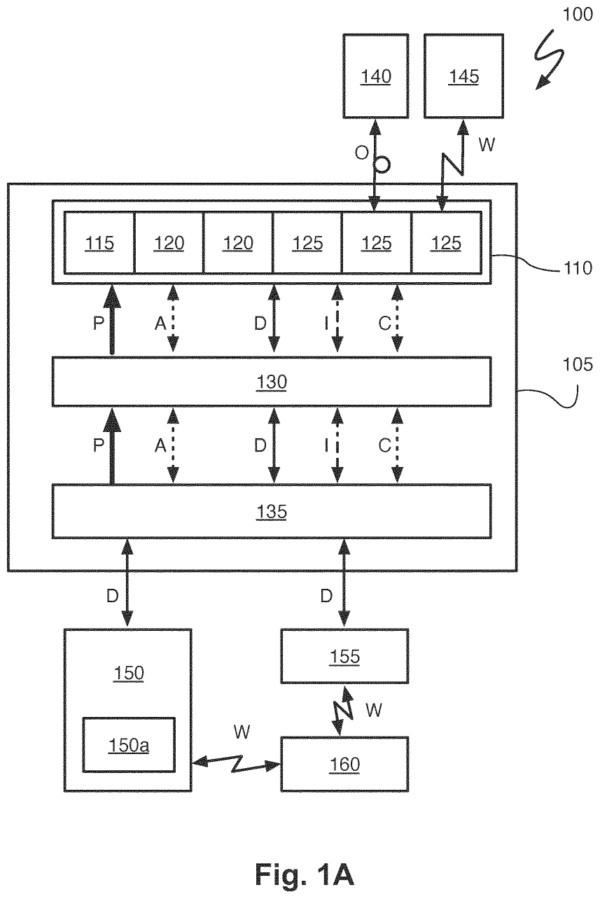

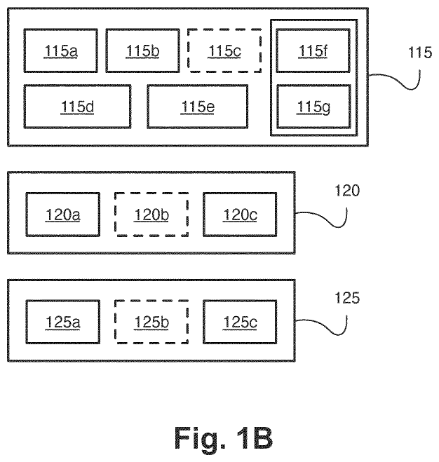

FIGS. 1A and 1B show a (first) block diagram 100 illustrating selected functional building blocks of an exemplary CCU 105 and a related high-level communication structure for communication within the CCU 105 and with CCU-external communication nodes 140, 145, 150 and 155/160.

CCU 105 comprises a (i) computer module cluster 110 that comprises a main computing module 115, one or more general purpose computing modules 120, and one or more special purpose modules 125, (ii) a service module 135, and (iii) a connection device 130, such as a backplane (which may particularly be a passive backplane), for interconnecting the modules both among each other and with the service module 135.

The interconnections provided by the connection device 130 may particularly comprise power connections for exchanging power P, such as electrical power, data connections (e.g., Ethernet, PCI, or PCIe) for exchanging data D, control connections (e.g., I²C) for exchanging control information C, alarm connections for exchanging alarm information A, and power management connections for exchanging power management information I.

In the example of FIG. 1A, the CCU-external communication nodes comprise a first endpoint cluster 140 which is optically connected, for example via a fiber communication link O, to CCU 105, a second endpoint cluster 145 that connected via a wireless communication link W, e.g., a Bluetooth, WLAN, ZigBee, or cellular mobile connection link, to CCU 105. A further endpoint cluster 150, which may particularly be or comprise a zonal hub for interconnecting the CCU to further endpoints, may be connected by a cable connection. A yet further endpoint cluster 160 may be connected to CCU 105 via a separate intermediate wireless transceiver 155.

Furthermore, two or more of the endpoint clusters may be directly linked with each other by communication links that do not involve CCU 105, as exemplarily illustrated with a wireless link W between endpoint clusters 150 and 160. Each of the endpoints is a node within the communication network being formed by the communications links connecting the endpoints directly or indirectly to CCU 105 or among each other. Particularly, an endpoint may be or comprise one or more of an actuator, a sensor, and an intermediate network node, e.g., hub, for connecting multiple other endpoints. The term “endpoint cluster”, as used herein, refers to a set of endpoints which are connected directly or indirectly via respective communication links to a same network node so that all of them can exchange information with that common node. Typically, this common node will have some sort of hub functionality, i.e., serve as an intermediate node in a communication link between other nodes being connected to it.

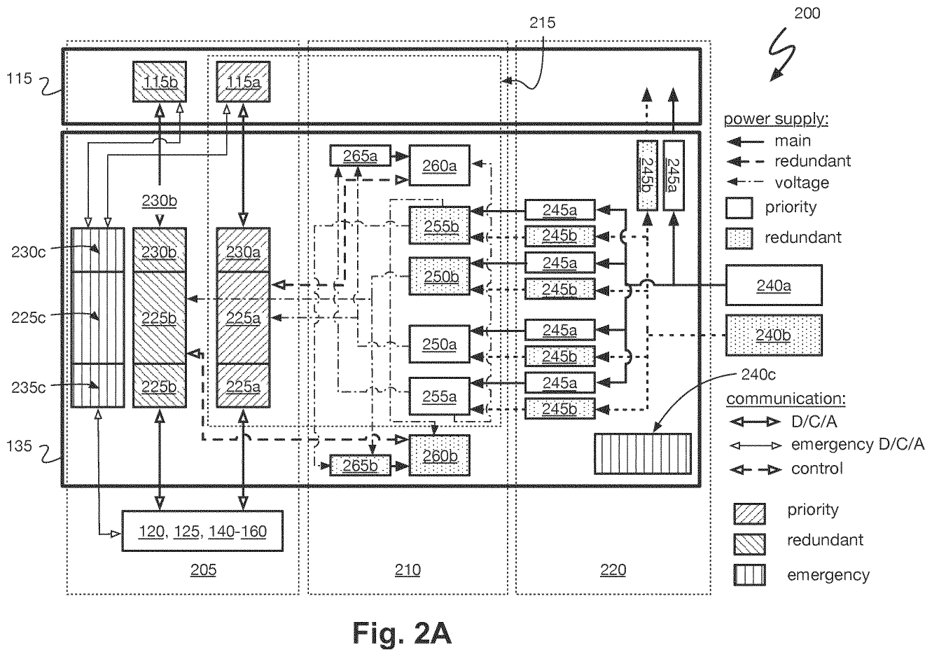

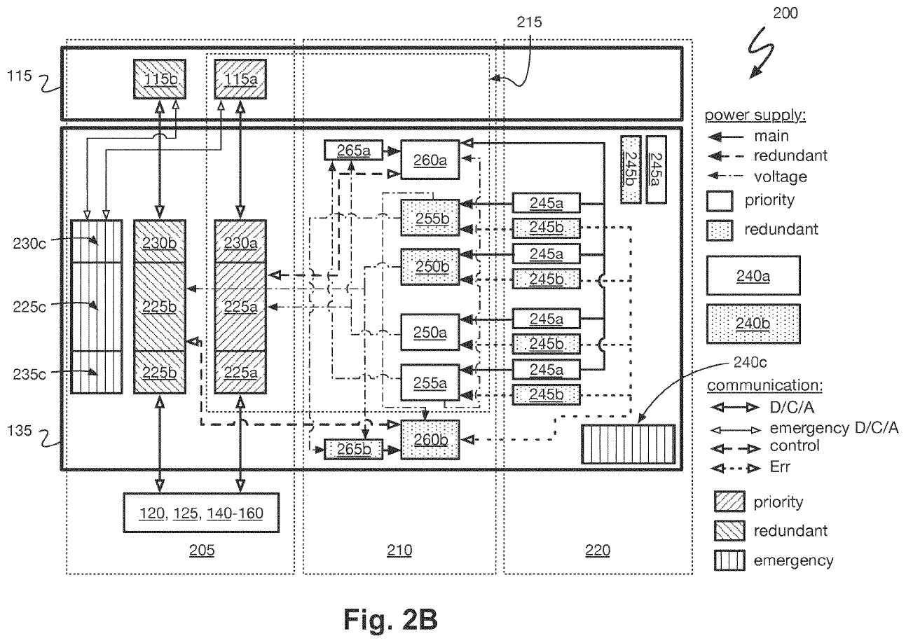

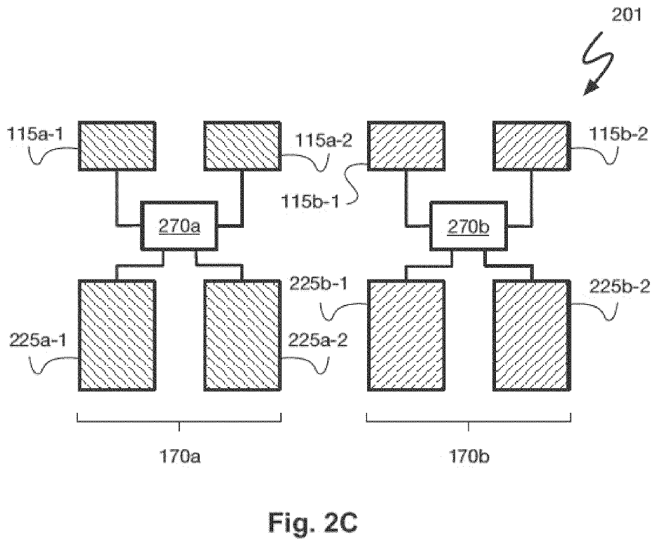

CCU 105 further comprises (not shown in FIGS. 1A and 1B) a communication switch and a power supply system. These building blocks of CCU 105 will be discussed further below with reference to FIGS. 2 to 5.

Reference is now made to FIG. 1B, which illustrates modules 115, 120 and 125 of the computing module cluster 110 of FIG. 1A in more detail. Turning first to module 115, which has the function of a main computing module and comprises within the module 115 (thus in co-location) at least a first computational entity (CE) 115a and a separate second computational entity 115b and optionally one or more further CEs 115c. All of these CEs are autonomous and independent from each other in the sense that all of them have comparable, ideally identical, and computing capabilities and their respective own individual memory, so that each of these CES can serve as a replacement for a respective other one of these CES.

In the further discussion, for the sake of simplicity and without limitation, an exemplary case is considered where beyond CEs 115a and 115b no further CEs 115c are present in the main computing module 115. Each of CEs 115a and 115b may be embodied in a respective separate hardware unit, such as a semiconductor chip, e.g., a system-on-chip (SOC).

The two CEs 115a and 115b are configured, e.g., by a respective software (computer program(s)), to work redundantly in such a way that they synchronously perform identical computing tasks to enable a proper functioning of the CCU for as long as at least one of the CEs 115a and 115b is properly working. Accordingly, there is not only a redundancy among CEs 115a and 115b in terms of a redundant hardware, but also in terms of the computing tasks they perform synchronously, such that if one of the CEs 115a and 115b fails (with or without prewarning), the respective other one of these CEs can immediately step-in and thus maintain the computing functionality of the main computing module 115 based on its own already ongoing synchronous performance of the same computing tasks.

Now, before continuing with an explanation of the remaining building blocks of main computing module 115, reference is made to general purpose computing module 120. Module 120 comprise at least on autonomous CE 120a and optionally one or more further CEs 120b. CEs 120a and 120b are designed as general-purpose computing entities, i.e., computing entities which are designed to perform all kind of different computing tasks rather than being limited to performing only computing tasks of one or more specific kinds, such as graphics or audio processing or running an artificial neural network or some other artificial intelligence algorithm. Each of CES 120a and 120b have their own memory and are independently from other CEs capable of performing computing tasks having been assigned to it autonomically.

In addition, each module 120 comprises a respective individual fault management system (FMS) 120c, which is configured to detect malfunctions, such as hardware and/or software-based errors or defects, occurring within or at least with an involvement of module 120. FMS 120c is further configured to communicate any such detected malfunctions to the main computing module 115 via the connection device 135 by means of alarm information A.

Turning now to special purpose module(s) 125, in contrast to general purpose computing module(s) 120, special purpose module 125 is designed specifically to perform one or more selected tasks, such as computing tasks or communications tasks, and is generally less suitable or even incapable of performing general computing tasks like module(s) 115 and 120. For example, one or more of special purpose module(s) 125 may be or comprise a graphics processing unit (GPU), a module being specifically designed to run one or more artificial intelligence algorithms, a neural processing unit (NPU), or an in-memory compute unit (IMCU) or a local hub module. Accordingly, a special purpose module 125 may particularly comprise one or more CEs 125a and/or one or more communication interfaces 125b for establishing communication links, such as links to endpoints or endpoint clusters. Each CE 125a has its own memory and is independently from other CEs capable of performing computing tasks having been assigned to it autonomically.

In addition, also each of module(s) 125 comprises a respective individual fault management system (FMS) 125c, which is configured to detect malfunctions, such as hardware and/or software-based errors or defects, occurring within or at least with an involvement of module 125. FMS 125c is further configured to communicate any such detected malfunctions to the main computing module 115 via the connection device 135 by means of alarm information A.

While computing module cluster 110 may thus comprise one or more general-purpose computing modules 120 and/or one or more special purpose modules 125, and/or even other modules, it may, in a simple form, be implemented without such additional modules such that only main module 115 remains as a computing module. Particularly, it is possible to implement computing module cluster 110 or any one or more of its computing modules 120, 125 based on a set of interconnected chiplets as components thereof.

Returning now to main computing module 115, among all modules, this module 115 takes—amongst other roles—the role of assigning tasks, including particularly computing tasks, to the various modules 115, 120 and 125 of the computing module cluster 110. This assignment process thus provides a resource coordination functionality 115d for the computing module cluster 110. CEs 115a and 115b may thus be designated “master CEs” while the other CEs within modules 120 and 125 are at the receiving end of such task assignment process and may thus be designated “slave CEs”, as they have to perform the tasks being assigned to them by the master CE(s).

The assignment of tasks as defined by the master CE(s) 115a/115b is communicated to the slave CEs by means of message passing via the connection device 130, thus communicating, for example, corresponding control information C and/or data D.

Particularly, the resource coordination functionality may comprise a process wherein the main computing module 115 receives periodic reports of major software operations (including parallel & sequential operations) on all CCU processes (running on the set of CEs) and the current priority master CE 115a assigns tasks between and towards the various CEs based on such reports (while the other master CE 115b synchronously runs the same process, although its related task assignments will be discarded). Instead, or in addition, the assignment may depend on an amount of available energy that is currently available to power the CCU.

While such assignment may even include an assignment of computing tasks to the master CEs 115a, b themselves, such assignment will address both master CEs 115a, b similarly so that both will then perform such self-assigned tasks synchronously, thus maintaining the fully redundant operation of both master CEs 115a, b.

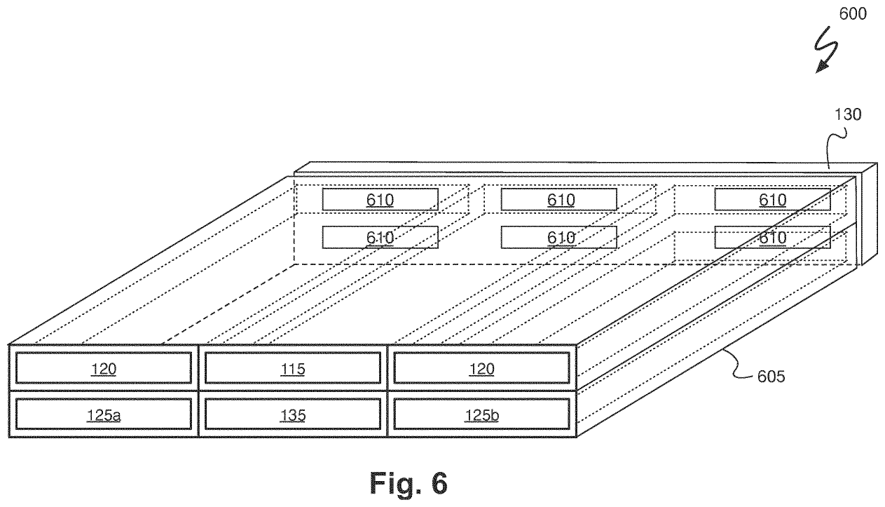

Overall, the set of CEs of the various modules, which are co-located, as will be explained in more detail below with reference to the exemplary embodiment of a CCU in FIG. 6, thus forms a distributed computing system (DCS) in which computing tasks to be performed by the DCS as a whole can be variably assigned to different CEs within computing module cluster 110, and wherein such assignment is communicated by way of message passing among the involved CEs.

The main computing module 115 further comprises a central fault management system (CFMS) 115f which is configured to receive via alarm information A provided by one or more of the FMS of the other modules or even from an own individual FMS 115g of the main computing module 115 itself, fault associated anomalies having been detected within the DCS. CFMS 115f is configured to categorize and classify such alarm information A and to initiate countermeasures, such as a reassignment of computing tasks from a defect CE or module to another module or in case of insufficient remaining computing power, a prioritization of the tasks such as to support the more important tasks at the cost of less important ones.

The main computing module 115 further comprises a safety management system (SMS) 115e that is configured to take decisions on and if needed initiate necessary safety measures (i.e., safe state escalation incl. real time scheduling) to bring the CCU and/or the vehicle it helps control into a safe state. Accordingly, safety management system 115e may particularly rely as an input on the alarm information A being available from the CFMS which in turn consolidates the alarm information received from the various individual FMS of the various modules of the CCU 105.

If, for example, the alarm information A (or some other information being available to SMS 115e indicates a loss of power in the power supply for CCU 105, SMS 115e might take a decision to use all remaining power for steering the vehicle to the roadside while turning off the power supply to all non-essential systems of the vehicle. Such non-essential systems might for example relate to air conditioning or entertainment, and to such modules of the CCU 105 which are not needed for essential tasks for enabling the process of safely steering the vehicle to the roadside. Such essential tasks might for example include turning on the warning lights and tasks related to the braking system of the vehicle.

The central fault management system CFMS 115f and the resource coordination functionality RCOS are for example implemented in a redundant manner in multiple instantiations, such that a failure of one instantiation can be compensated by another instantiation. Particularly, each CE 115a and 115b may have an associated different one of such instantiations so that each of CEs 115a and 115b is autonomous including an autonomous central fault management system CFMS 15f and the resource coordination functionality RCOS.

Each of the RCOS 115d, SMS 115e, CFMS 115f, and FMS 115g may particularly be implemented in whole or in parts as one or more computer programs designed to run synchronously (in separated instantiations) on each of master CES 115a, 115b. Hybrid implementations are possible too, wherein dedicated hardware is provided in addition to the one or more processors for running the software to enable a selective offloading of certain tasks, e.g., to a high-performance dedicated system-on-chip, Soc).

FIG. 2A illustrates, according to embodiments of the present solution, a second block diagram 200 showing more details of the functional building blocks of the CCU of FIG. 1, with a focus on a redundant set-up thereof.

As already discussed above with reference to FIGS. 1A and 1B, the computing module cluster 110 comprises within its main computing module 115 two or more master CEs, in the present example master CEs 115a and 115b. Accordingly, redundancy is available at the level of master CEs.

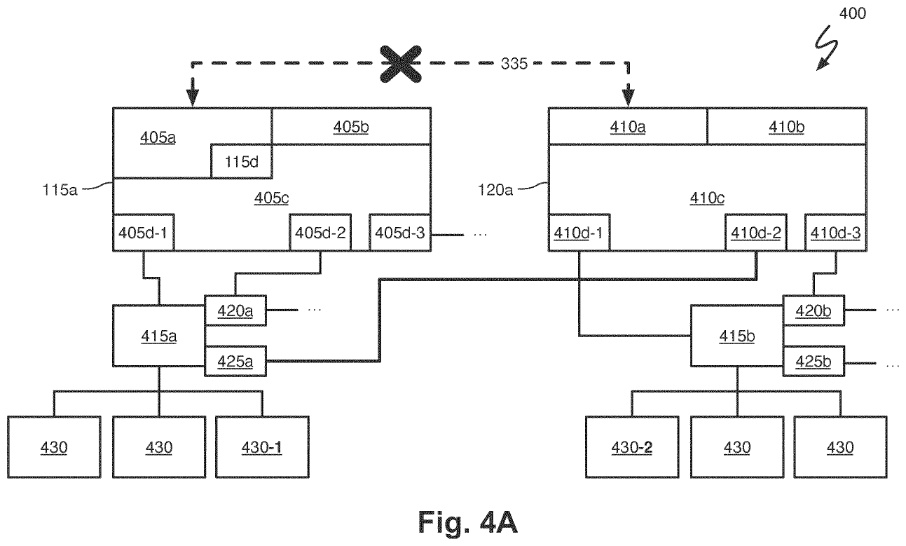

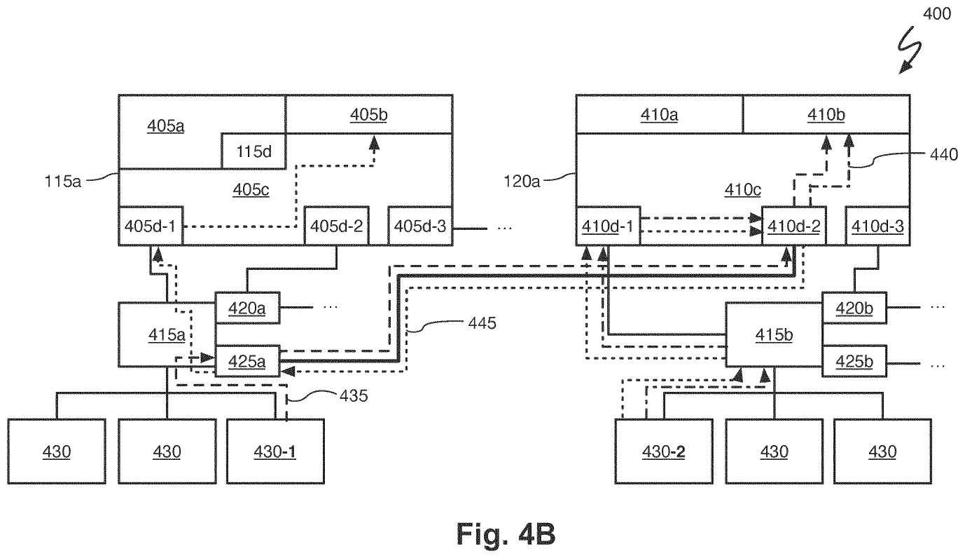

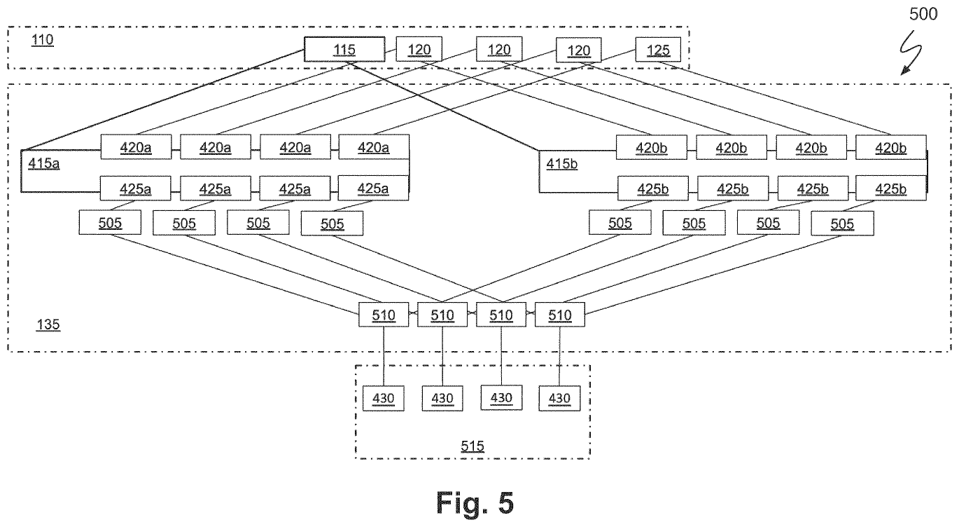

Furthermore, CCU 105 comprises a communication switch which in turn comprises a plurality of mutually independent switching fabrics. In the example of FIG. 2A, there are two independent autonomously operating (main) switching fabrics 225a and 225b, and a third switching fabric 225c for emergency situations. All switching fabrics 225a, b, c are provided within service module 135. Each switching fabric 225a, b, c comprises hardware for variably connecting multiple different nodes of a network, such as nodes of a computer network, to variably exchange data therebetween. In the present example, the network comprises as nodes the modules of computing module cluster 110 and the various endpoints or endpoint clusters thereto, for example as illustrated in any one or more of FIG. 1A, FIG. 4A/B and FIG. 5. Each of the (main) switching fabrics 225a and 225b is signal connected to an associated one of the master CEs in main computing module 115, so that it can selectively switch flows of information between the respective master CE 115a or 115b and other nodes, such as nodes 120, 125 and 140 to 160, of the network. Specifically, the switching fabrics may be designed as switches conforming to the PCI Express (PCIe) industry standard (PCIe switch). The same applies to the third switching fabric 225c, although it may have a restricted connectivity. For example, it may be connected to only a true subset of the set of endpoints and/or to only a true subset of the set of slave CEs 120a, 120b, 125a, or even to none of these CEs.

For security purposes, the network connections between the switching fabrics and other nodes of the network may be protected by one or more security functions 230a, b and 235a, b, such as authentication, packet inspection, encryption, digital signatures, and/or obfuscation and may involve offloading to specified security devices. Particularly, the security functions may be implemented as building blocks of the respective associated switching fabric, as illustrated in FIG. 2A, B, where authentication and packet inspection are provided in each of security blocks/functions 235a and 235b as a guarding function at the endpoint side of the fabrics, while one or more of the other security functions may be provided in each of security blocks/functions 230a and 230b at the CE side of the switching fabrics 225a, 225b and 225c.

The main computing module 115 with master CEs 115a and 115b and the switching fabrics 225a, 225b and 225c with their related security functions/blocks can be said to define together a computing task coordination domain 205 of CCU 105, wherein computing tasks can be assigned variably among the modules of computing module cluster 110. The CCU may particularly be configured to fully enumerate all nodes of the network during a boot process and/or a reset process such that upon completion of these processes all nodes have a defined identity within the network, e.g., an assigned identification code by which they can be unambiguously identified within the network. The enumeration process may particularly be performed under the guidance of the communication switch and/or the main computing module 115.

In order to avoid any confusion, at each given point in time, only one of the master CEs 115a, 115b is defined (e.g., by a related flag) as a current priority master CE, which means that the other entities of the CCU will only “listen” to its commands (such as assignments of computing tasks) while ignoring any commands coming from any of the other master CEs. In FIG. 2, master CE 115a is currently defined as current priority master CE while master CE 115b is not.

This is indicated in FIG. 2A by hatching, wherein the current priority master CE 115a and all other building blocks of block diagram 200, which are specifically associated with the current priority master CE 115a are shown in “downward” hatching and the reference number attribute “a” (such as in “225a”), while the other master CE 115b as well as all other building blocks of computing task coordination domain 205 which are specifically associated with the other master CE 115b are shown “upward” hatching and the reference number attribute “b” (such as in “225b”).

If a malfunctioning of the current priority master CE 115a or of a switching fabric 225a being associated therewith is detected, the other/another master CE 115b, which is determined to work properly (e.g., by a build-in-self test), as the new priority master CE such that the new priority master CE takes over the role previously held by the malfunctioning current master CE. The same applies to the associated switching fabrics. If, for example, current priority master CE 115a and/or its associated switching fabric 225a are found to be malfunctioning, e.g., due to a hardware defect, then previously redundant master CE 115b and its associated switching fabric 225b are determined to now have priority and take-over the roles previously taken by master CE 115a and its associated switching fabric 225a.

Furthermore, in an emergency situation, such as when in addition also the other switching fabric 225b (now acting as new priority switching fabric) is found to be malfunctioning, the third switching fabric 225c may be determined to now get priority and take-over the role of the previous priority switching fabric 225a or 225b. If the third switching fabric 225c has a restricted connectivity, as discussed above, then all non-connected endpoints and CES will automatically be disconnected from the switching functionality of the service module 135 when the third switching fabric 225c takes over. In this way, the CCU can focus on emergency tasks, even without having to involve the resource coordination functionality. The CCU 105, e.g., its service module 135, may comprise a further power source such as an emergency power source 240c. It may particularly be designed as a mere interim power source with a more limited capacity than the main power sources 240a and 240b, but enough capacity to power at least the third switching fabric 225c, if in operation.

Turning now to the power supply system for CCU 105, there are two (or more) redundant, mutually independent power sources 240a and 240b, each of which is individually capable of providing enough power, such as electrical power, to the CCU 105 to support all of its functions, at least under normal operating conditions. In normal operation, all of these power sources are configured to operate simultaneously to jointly provide a redundant and thus highly-reliably power supply to the CCU 105. The power sources 240a and 240b may be components of CCU 105 itself or may be external thereto, e.g., as CCU-external vehicle batteries.

To further support the redundancy concept, on which CCU 105 is based, for each of the power sources 240a and 240b there is an individual independent power network (cf. “main” path and “redundant”path, respectively in FIGS. 2A and B) for distributing the power provided by the respective power source 240a or 240b among the physical components of CCU 105 which have a need to be powered, including—without limitation—all CEs in each computing module and all switching fabrics 225a and 225b. Specifically, each power source 240a and 240b and its respective power network is configured to simultaneously power all switching fabrics such that full redundancy is achieved and operation of CCU 105 can be maintained even in cases where one switching fabric or one power source fails.

Current limiters 245a, b may be provided within the power networks to provide that any currents flowing in power lines of the CCU 105, particularly in its service module 135, remain below a respective defined current threshold in order to avoid any current-based damages or malfunctions which might occur if current levels were to rise beyond such respective thresholds. The power networks and optionally also the power sources 240a, 240b (if part of the CCU 105) define a power supply domain 220 of CCU 105, which provides a high degree of reliability due to its redundant set-up.

The various hardware components of CCU 105 might have different voltage requirements for their power supply. Accordingly, the power system of CCU 105 may further comprise various redundantly provided, voltage generation units each being configured to provide a same set of different power supply voltage levels as needed and distributed to the fabrics 225a, b, c—through the backplane. For example, a first voltage level may be at 3.3 V for powering a first set of devices, such as Ethernet to PCIe bridges of CCU 105, while a second voltage level may be at 1.8 V for powering a second set of devices, such as microcontrollers and NOR Flash memory devices of CCU 105, a third voltage level may be at 0.8 V for powering a third set of devices, such as DRAM memory devices of CCU 105, etc. This allows the control coordination domain 210 of CCU 105 to control the voltage levels of the entire service module 135 as well as those generated within the compute cluster 110 directly supplied from 145a/b by control through the computing task coordination domain 205.

Particularly, voltage generation units 250b and 255b generate a same set of voltages. Voltage generation unit 250b provides the full set of voltage levels to fabric 225b, while voltage generation unit 255b provides the same full set of voltage levels to the controller 260b. The controller compares the voltage set delivered by voltage generation unit 250b to fabric 225b with the set received from voltage generation unit 255b—which should be identical. If the controller determines, however, that the voltage level sets do not match, a problem is detected and a reaction may be initiated by the controller, e.g., the switching off of one or more components. The same applies mutatis mutandis for voltage generation units 250a and 255a.

All voltage creation units 250/255a/b individually generate the set of output voltages based on a load sharing or voting process in relation to the power supplied simultaneously from power sources 240a and 240b. For example, power supply sharing may be applied, when both power supplies are found to be stable, while voting may be applied in case one power supply is unstable.

In addition, CCU 105, namely its service module 135, comprises two or more mutually redundant controllers, e. g., microcontrollers, 260a, 260b for controlling selected functions of service module 135. Particularly, microcontrollers 260a, 260b may be configured to control, using power management information I, a power supply for the communication switch with switching fabrics 225a and 225b.

Service module 135 further comprises a monitoring functionally which is also redundantly implemented in at least two independent instantiations, e. g., hardware components, 265a and 265b. The monitoring may particularly comprise a monitoring of one or more of a current monitoring, voltage monitoring and clock monitoring. Such monitoring may particularly relate to the power outputs of the voltage generation units 250a, b and 255a, b. The monitoring results are provided to the controllers 260a, b where they are analyzed and control signals C defining a reaction to the results of the analysis and/or in case of a detected malfunction alarm information (signals) A may be issued and communicated to relevant other components of CCU 105, such as the CFMS 115f in the main computing module 115 and/or some other safety function of CCU 105, if any. The CFMS 115f can thus react accordingly, such as by reassigning current or upcoming computing tasks to CEs that are not affected by the detected malfunctioning.

The controllers 260a, b, the voltage generation units 250a, b and 255a, b and the monitoring units 265a, b thus may be designated as a control coordination domain 210 of the service module 135. In fact, grouping now separately the components of the priority path (i.e., being associated with the current priority master CE 115a) on the one hand and the components of the redundant path (i.e., being associated with the currently other master CE 115b) on the other hand, for each master CE 115a, b a respective associated fabric power coordination domain may be defined that comprise the components of the associated group. In FIG. 2, only one of this fabric power coordination domains are drawn (dashed frame) and denoted with reference sign 215.

As illustrated in FIG. 2B (the power supply paths are not shown here to reduce the complexity of the drawing), the current limiters 245a, b may particularly be equipped with a diagnostic output functionality so as to generate and output diagnostic data based on the operation of the respective current limiter and/or characteristics of the power it receives or provides. The diagnostic data can then be provided to the controllers 260a, b for further analysis and for initiating adequate reactions, e.g. changing the priority from one master CE 115a or 115b and its associated switching fabric 225a or 225b to the other master CE 115b or 115a and its associated switching fabric 225b or 225a, if the diagnostic data indicates a failure or malfunctioning of one or more components of the CCU 105 that may affect a proper functioning of the current priority master CE and/or its associated switching fabric.

As shown in FIG. 2C, the set-up illustrated in FIGS. 2A and 2B may be further enhanced by adding a further level of redundancy beyond the fundamental redundancy provided by the concept of two or more pairs 170a, 170b each having an associated master CE 115a (or 115b) and an associated switching fabric 225a (or 225b), as discussed above. Said further level of redundancy is based on a concept 201 of providing redundancy within such a pair by providing the master CE and/or the switching fabric of the pair redundantly (i.e., in multiple instantiations) and further providing per such pair a configuration switch 270a, 270b for switching between different configurations of the pair.

Accordingly, if a redundantly provided master CE and/or a redundantly provided switching fabric within a given pair fails, the pair as a whole is still operable because of the remaining one or more other master CE(s) and/or switching fabric(s), respectively. The priority concept discussed above for the fundamental redundancy between pairs may be adopted similarly for the further redundancy level within a given pair 170a (or 170b). Accordingly, if a pair 170a (or 170b) has multiple redundant master CEs 115a and 115b, they may be operated so as to simultaneously perform the same computing tasks while one of the master CEs 115a-1 and 115a-2 (or 115b-1 and 115b-2) is defined as a priority master CE of that pair 170a (or 170b). The same applies to the switching fabrics per pair when a pair has multiple switching fabrics 225a-1 and 225a-2 (or 225b-1 and 225b-2).

By way of example, FIG. 2C illustrates two separate ones of such pairs 170a and 170b. Unless such pair consists of a single master CE, (e. g. master CE 115a-1) and a single switching fabric (e.g. switching fabric 225a-1) (“I-shape”), it comprises an own configuration switch 270a (or 270b) and either two (or more) associated master CEs, such as master CEs 115a-1 and 115a-2 (or 115b-1 and 115b-2), or two (or more) associated switching fabrics, such switching fabrics 225a-1 and 225a-2 (or 225b-1 and 225b-2). The configuration switch 270a (or 270b) is operable to variably switch between at least two different possible configurations of the respective pair 170a (or 170b).

Exemplary shapes per pair 170a (or 170b) are: (i) multiple master CEs 115a-1 and 115a-2 (or 115b-1 and 115b-2) and a single switching fabric 225a-1 (or 225b-1) (“Y-shape”) ; (ii) a single master CES 115a-1 (or 115b-1) and multiple switching fabrics 225a-1 and 225a-2 (or 225b-1 and 225b-2) (“inverted Y-shape”) ; and multiple master CEs 115a-1 and 115a-2 (or 115b-1 and 115b-2) and multiple switching fabrics 225a-1 and 225a-2 (or 225b-1 and 225b-2) (“X-shape”). The pairs 170a and 170b may have a same or a different shape in general or at a given point in time. For example, pair 170a may have a Y-shape and pair 170b may at the same time have an X-shape. If a pair 170a (or 170b) has a shape other than the I-shape, it can be configured using its configuration switch 270a (or 270b), particularly based on the operational state of its components, such as error-free operation or malfunction/failure. If, for example, pair 170a has an X-shape or an inverted Y-shape, and a failure of switching fabric 225a-2 is detected, the configuration switch 270a can be (re-) configured so that it now connects the other (error-free) switching fabric 225a-2 to the current priority master CE of the pair, e. g., master CE 115a-1.

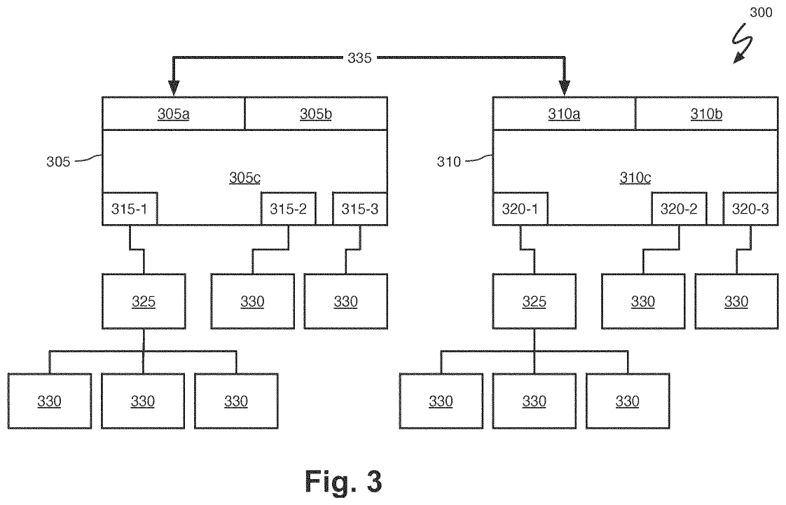

Referring now to FIG. 3, which illustrates an exemplary conventional classical strictly hierarchical communication scheme 300 according to the standardized PCI Express (PCIe) communication technology, for communication between different nodes of a PCIe network, including, in particular, two different computing entities, such as central processing units (CPUs) 305 and 310. CPU 305 comprises a management functionality 305a, e.g., for scheduling computing tasks, a processing functionality 305b for performing the scheduled computing tasks, and a PCIe root complex 305c with three PCIe root ports 315-1, 315-2 and 315-3.

Similarly, CPU 310 comprises a management functionality 310a, e.g., for scheduling computing tasks, and a processing functionality 310b for performing the scheduled computing tasks, and a PCIe root complex 310c with three PCIe root ports 320-1, 320-2 and 320-3.

All communication flows between such a CPU, e.g., CPU 305, and any endpoint 330 in an PCIe network being associated with the CPU have to go through the CPU's root complex 305c using one or more of its root ports 315-1, 315-2 and 315-3. In addition to PCIe endpoints 330, there may be intermediate hubs in the PCIe network, such as on or more PCIe switches 325.

Accordingly, each CPU 305 and 310, respectively, has an own communication hierarchy including an own address space and/or clock domain for communication between any two nodes of its PCIe network, so that due to the hierarchy, every communication between two nodes of the same network must necessarily pass through the root complex of the associated CPU.

Communication between nodes of different communication hierarchies is enabled via an inter-CPU communication link 335 running between CPUs 305 and 310. Accordingly, if a first endpoint 330 being located in the communication hierarchy of CPU 305 needs to communicate with a second endpoint 330 being located in the communication hierarchy of the other CPU 310, then the communication path has to run
from the first endpoint upstream through the communication hierarchy of CPU 305
through root complex 305c with a relevant root port 315,
through the management functionality of CPU 305,
then further over the inter-CPU communication link 335 to the second CPU 310, and
there in a downstream direction through its management functionality of 310a,
its root complex 310c and a relevant root port 320 thereof,
and, finally, to the second endpoint.

Accordingly, because the endpoints of different communication hierarchies are isolated from the CPU of the respective other CPU, such a communication is not very efficient and may particularly suffer from a high latency.

In contrast to the conventional approach of FIG. 3, embodiments of the present solution may implement an adapted PCIe communication scheme 400, as illustrated in FIGS. 4A and 4B.

Also in this exemplary scheme 400, there are two PCIe hierarchies, each having its own address space and a respective single root complex 405c and 410c respectively. In scheme 400, the first CPU 305 of FIG. 3 is replaced by a master CE, e.g., master CE 115a of FIG. 1B, and the second CPU 310 is replaced by a slave CE, e.g., slave CE 120a of FIG. 1B.

Master CE 115a comprises a management functionality 405a, a processing functionality 405b, and a PCIe root complex 405c with three PCIe root ports 405d-1, 405d-2, and 405d-3. Similarly, slave CE 120a comprises a management functionality 410a, a processing functionality 410b, and a PCIe root complex 410c with three PCIe root ports 410d-1, 410d-2 and 410d-3, and resource coordination system block 415d comprising the resource £ coordination functionality (RCOS). All nodes of scheme 400 share a common clock, i.e., they are in a same clock domain.

In each communication hierarchy, there is a PCIe switch 415 having one or more Non-transparent PCIe Bridges (NTB) 420a for connection with the associated CE and one or more Non-transparent PCIe Bridges (NTB) 425a for direct or indirect connection with one or more endpoints or the respective other communication hierarchy, namely its root complex. The inter-CPU communication link 335 of FIG. 3 has now become obsolete and can be dispensed with.

Referring now particularly to FIG. 4B, three exemplary communication paths are shown which are enabled by the adapted PCIe communication scheme 400.

A first communication path 435 enables a communication between a selected endpoint 430-1 in the hierarchy of master CE 115a and the slave CE 120a, specifically its processing functionality 410b. The first communication path 435 runs from endpoint 430-1 to PCIe switch 415a in the same hierarchy and from there over NTB 425a to root point 410d-2 of the root complex 410c of the other CE, namely slave CE 120a, from where it finally runs to processing functionality 410b.

A second communication path 440 enables a communication between a selected endpoint 430-2 in the hierarchy of slave CE 120a and the processing functionality 410b of slave CE 120a. Accordingly, the second communication path remains within a same hierarchy from endpoint 430-2 to PCIe switch 415b to root point 410d-1 and from there through root point 410d-2 to its processing functionality 410b, i.e., that of slave CE 120a, like in the conventional case of FIG. 3.

A third communication path 445 enables a communication between a selected endpoint 430-2 in the hierarchy of slave CE 120a and another selected endpoint 430-1 in the hierarchy of master CE 115a. The third communication path 445 runs from endpoint 430-2 to PCIe switch 415b in the same hierarchy to root point 410d-1 of the root complex 410c of slave CE 120a and there further to root point 410d-2 from where it reaches over NTB 425a the PCIe switch 415a, from where it finally proceeds to processing functionality 405b.

All of these communication paths, particularly the first and the third path which interconnect different hierarchies, can be managed by the management functionality 405a of master CE 115a. The scheme 400 therefore uses NTBs to enable “direct” point-to-point communication between distributed locations within the same clock domain, including in different hierarchies, while the communication paths are managed, particularly configured, centrally.

FIG. 5 illustrates, according to embodiments of the present solution, a third block diagram 500 showing more details of an exemplary CCU, particularly of its communication switch with service module 135. This CCU has a computing module cluster 110 comprising a main computing module 115, three general purpose computing modules 120, and a single special purpose module 125, each of the respective kind described above in connection with FIGS. 1A and 1B.

Each of the modules of computing module cluster 110 is linked to two PCIe switches 415a and 415b. Each of the PCIe switches 415a and 415b is equipped with a number of NTBs 420a/420b at the CE side and a number of further NTBs 425a/425b at the endpoint side. Accordingly, so far this setup is similar to that of FIG. 4A/4B, albeit optionally with a different number of NTBs.

In addition, the CCU of diagram 500 comprises for one or more, particularly all endpoint-side NTBs 425a, b a respective bridge 505 for performing a conversion between different communication technologies used in a related communication path running through the respective NTB. For example, such a bridge might be configured to perform a conversion from an Ethernet communication technology to a PCIe technology. Specifically, in the example of FIG. 5, the brides are configured to perform a conversion from an Ethernet communication technology at the endpoint-side to a PCIe technology at the CE-side of the NTB.

Thus, PCIe technology is used for the communication among the modules of computing module cluster 110 and with the PCIe switches 415a, b, and toward the bridges 505, while Ethernet technology is used to communicate between the bridges 505 and the endpoints 430. The latter may particularly be arranged, spatially or by some other common property such as a shared functionality, address space, or clock, in an endpoint cluster 515. Between the bridges 505 and endpoint cluster 515 Ethernet switches 510 may be arranged to variably connect selected individual endpoints 430 to selected bridges 505. The set of PCIe switches 415a, b and bridges 505 may particularly be realized within a single SoC or by means of a chiplet solution where the PCIe switches 415a, b and bridges 505 are distributed across multiple chiplets, each chiplet bearing one or more of these components.

Accordingly, each module of computing module cluster 110 is connected to each of the two switching fabrics, each switching fabric comprising a respective PCIe switch 415a, b, various NTBs 420a/425a or 420b/425b and a number of bridges 505. In this way, the desired redundancy is achieved, where each endpoint 430 may be reached (and vice versa) via each of the communication fabrics and from any module of computing module cluster 110.

FIG. 6 illustrates, according to embodiments of the present solution, an exemplary housing 600 of an exemplary CCU, e.g., the CCU 105 of FIG. 1. Housing 600 comprises a rack-shaped housing structure 605 with a number of compartments, each for housing, for example in a replaceable manner, a module of the CCU 105 such as a computing module of computing module cluster 110 or the service module. In the present example, there are six compartments (slots) arranged in a fabric and housing in total (in co-location, specifically in a neighboring manner) the main computing module 115, two general purpose computing modules 120, two special purpose modules 125, and the service module 135.

While a first end of the housing structure 605 comprises for each compartment a respective opening for inserting or extracting a module, the opposing end of the housing structure 605 comprises a connection device 130 that is configured to provide connections for exchanging one or more of power P, data D, control information C, alarm information A or power management information I among different modules.

The connection device 130 may particularly have a substantially planar shape and may thus be designated a “backplane”. Between the connection device and the opposing rear faces of the modules there are one or more connectors 610 per module to provide the above-mentioned connections. Particularly, the connectors may be designed as detachable connectors so that the modules may be (i) inserted and connected simply by pushing them into their respective compartment until the associated one or more connectors are connected and (ii) extracted and disconnected simply by pulling them form the compartment and thereby detaching the connections.

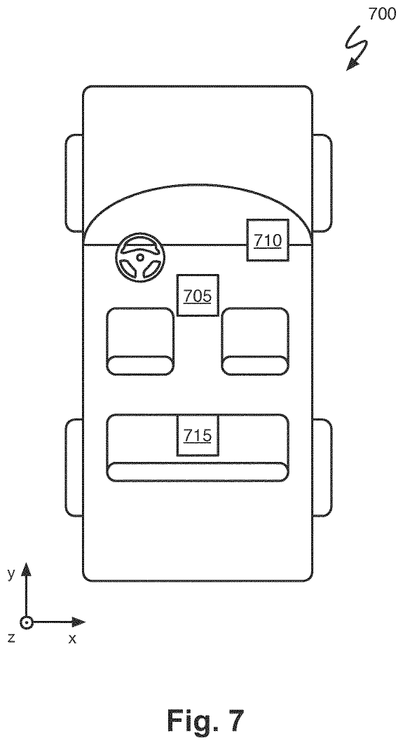

FIG. 7 shows a vehicle 700, particularly an automobile, being equipped with a CCU, such as CCU 105. The CCU is configured to centrally control different functionalities (not shown) of the vehicle 700.

Boxes 705, 710 and 715 identify three different exemplary locations within the vehicle 700, that are particularly suitable for placing the CCU within the vehicle 700. Locations 705 and 715 are arranged on or near the (virtual) centerline of the vehicle which centerline runs in the middle between the two side faces of the vehicle along the latter's main extension dimension (y dimension). While location 705 is between two front seats, e.g., in a middle console, of the vehicle 700, location 715 is under a rear seat or seat bench in a second or third seating row. These central locations (at least in x and y dimensions) are particularly beneficial in view of safety and protection from damages or destruction in case of an accident. They are also easily accessible for purposes of maintenance, repair, or replacement, particularly when one or more of the modules need to be extracted from the CCU.

Further exemplary location 710 is also highly accessible and is also protected well against crashes coming from almost any direction. This location 710 may also be particularly suitable for entertaining wireless communication links with communication nodes outside the vehicle, such as traffic infrastructure or car-to-car communication, because due to its position close to the windshield, it will typically suffer less from electromagnetic shielding by the vehicle 700 itself.

### LIST OF REFERENCE NUMERALS

100 first block diagram of CCU with CCU-external communication nodes
105 central computing unit, CCU
110 computing module cluster, distributed computing system
115 main computing module
115a first (master) CE
115a-1 first instantiation of first master CE
115a-2 second instantiation of first master CE
115b second (master) CE
115b-1 first instantiation of second master CE
115b-2 second instantiation of second master CE
115c optional one or more further (master) CEs
115d resource coordination functionality/system (RCOS)
115e safety management system (SMS)
115f central fault management system (CFMS)
115g (individual) fault management system (FMS) of main computing module
120 general purpose computing module
120a (slave) CE in module 120
120b optional one or more further (slave) CEs in module 120
120c (individual) fault management system (FMS) of module 120
125 special purpose module, e.g., GPU, AI module, NPU, or in-memory compute unit or local hub module
125a (slave) CE in module 125
125b communication interface, e. g., optical, or wireless interface
125c (individual) fault management system (FMS) of module 125
130 connection device, esp. backplane
135 service module
140 endpoint cluster, optically connected
145 endpoint cluster (remote), wirelessly connected
150 endpoint cluster, e.g., zonal hubs, connected via cable
150a wireless transceiver
155 separate wireless transceiver
160 endpoint cluster (remote)
200 second block diagram for illustrating functional domains of CCU
201 Redundancy concept
205 computing task coordination domain
210 control coordination domain
215 fabric power coordination domain
220 power supply domain
225a first switching fabric
225a-1 first instantiation of first switching fabric
225a-2 second instantiation of first switching fabric
225b second switching fabric
225b-1 first instantiation of second switching fabric
225b-2 second instantiation of second switching fabric
225c third switching fabric
230a, b security functions, CE side
235a, b security functions, endpoint side
240a, b (main) power sources
240c emergency power source
245a, b current limiters
250a, b first voltage generation units
255a, b second voltage generation units
260a, b controllers, e.g., microcontrollers
265a, b monitoring units, e.g., for monitoring current, voltage and/or clock
270a, b configuration switches
300 classical (conventional) PCIe communication scheme
305 first CPU
305a management functionality of CPU 305
305b processing functionality of CPU 305
305c root complex of CPU 305
310 second CPU
310a management functionality of CPU 310
310b processing functionality of CPU 310
310c root complex of CPU 310
315 root ports of root complex 305c
320 root ports of root complex 310c
325 PCIe switch
330 PCIe endpoint
335 inter-CPU communication link
400 adapted PCIe communication scheme
405a management functionality of master CE 115a
405b processing functionality of master CE 115a
405c root complex of master CE 115a
405d root ports of root complex 405c
410a management functionality of slave CE 120a
410b processing functionality of slave CE 120a
410c root complex of slave CE 120a
410d root ports of root complex 410 c
415a, b PCIe switch as switching fabric
420a, b non-transparent PCIe bridge (NTB), CE side
425a, b non-transparent PCIe bridge (NTB), endpoint side
430 (communication) endpoint
435 first communication path
440 second communication path
445 third communication path
500 third block diagram of CCU and an endpoint cluster
505 bridge, e.g., PCIe/Ethernet bridge
510 switch, e.g., Ethernet switch
515 endpoint cluster
600 housing
605 housing structure
610 connector
700 vehicle, esp. automobile
705 first exemplary location for CCU
710 second exemplary location for CCU
715 third exemplary location for CCU
A alarm information
C control information
D data
I power management information
P (electrical) power

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-37. (canceled)

38. A central computing unit (CCU) configured as an on-board computer for a vehicle, such as an automobile, to centrally control different functionalities of the vehicle, the CCU comprising:
a distributed computing system (DCS) comprising a plurality of co-located, autonomous computational entities (CEs) each of which has its own individual memory, wherein the CEs are configured to communicate among each other by message passing via one or more communication networks to coordinate among them an assignment of computing tasks to be performed by the DCS as a whole;
a communication switch comprising a plurality of mutually independent switching fabrics, each configured to variably connect a subset or each of the CEs of the DCS to one or more of a plurality of interfaces for exchanging thereover information with CCU-external communication nodes of the vehicle; and
a power supply system comprising a plurality of power supply sub-systems for simultaneous operation, each of which is individually and independently from each other capable of powering the DCS and at least two of the switching fabrics.

39. The CCU of claim 38, wherein the plurality of CEs comprises a group of two or more master CEs, which are configured to work redundantly in such a way that they synchronously perform identical computing tasks or data path coordination tasks to enable a proper functioning of the CCU for as long as at least one of the master CEs is properly working.

40. The CCU of claim 39, wherein:
the plurality of CEs further comprises one or more slave CEs; and
each of the master CEs comprises a resource coordination functionality being configured:
to define an assignment of the computing tasks variably among the CEs in a set comprising one or more of the slave CEs, and optionally the set of all master CEs; and
to communicate such assignment by message passing via the communication network to at least each CE which has to perform, according to this defined assignment, one or more selected computing task.

41. The CCU of claim 40, wherein the respective resource coordination functionality of one or more of the master CEs, is further configured to:
receive a periodic reporting of currently active computing tasks being performed by one or more the slave CEs; and
define said assignment of computing tasks based on the reporting.

42. The CCU of claim 40, wherein the respective resource coordination functionality of one or more of the master CEs is further configured to define said assignment of computing tasks based on an amount of energy that is currently made available by the power supply system to the CEs and/or to the switching fabrics.

43. The CCU of claim 40, wherein the respective resource coordination functionality is further configured to define said assignment of computing tasks such that
a computing task is assigned to different slave CES in parallel; and
a total result of the computing tasks is derived from the individual results generated by the involved slave CEs by a voting process based on one or more defined voting criteria.

44. The CCU of claim 39, wherein the CCU comprises a central fault management functionality which is configured:
to select from the group of two or more master CEs one particular master CE (115a) as a current priority master CE;
to execute the computing tasks by the CEs in the set of CEs according to the assignment defined by the current priority master CE, while discarding the assignments defined by all other master CEs; and
if a malfunctioning of the current priority master CE or of a switching fabric being associated therewith is detected, to select another one of the master CEs, which is determined to work properly, as the new priority master CE such that the assignment defined by the new priority master CE replaces the assignment defined by the malfunctioning current master CE.

45. The CCU of claim 44, wherein the central fault management functionality is further configured to detect a malfunctioning of the DCS or of the communication switch based on monitoring information representing measurements of one or more of:
a malfunctioning detected by an individual fault management functionality of a subsystem or individual component of the CCU;
an electric voltage, an electric current, a clock signal, and/or a data rate in one or more power lines or signal paths running between the power supply system and the DCS; and
a malfunctioning detected by the power supply system.

46. The CCU of claim 44, wherein the central fault management functionality is further configured:
to classify, according to a predetermined classification scheme, any detected malfunctioning to generate corresponding classification information representing one or more fault classes of the classification scheme being assigned to the malfunctioning per the classifying; and
to react to any detected malfunctioning based on the one or more fault classes being assigned to such malfunctioning.

47. The CCU of claim 44, wherein the central fault management functionality is further configured:
to monitor a time-evolution of one or more differences relating to signal propagation and/or signal integrity between two equal signals propagating simultaneously through two or more synchronously operating ones of the switching fabrics;
to determine, based on the monitored time-evolution of the differences, at least one of an aging indicator indicating an age or an age progress of at least one of the switching fabrics and an indicator for a cyber-attack against the CCU; and
when a potentially critical aging condition or a cyber threat is detected based on the one or more indicators, to initiate one or more counter measures.

48. The CCU of claim 44, wherein:
each of the master CEs has a single exclusively associated one of the switching fabrics being configured to connect the respective master CE to one or more of the plurality of interfaces for exchanging thereover information CCU-external communication nodes; and
said selecting of one particular master CE as the current priority master CE comprises selecting from the plurality of switching fabrics that switching fabric which is associated with the current priority master CE as a single currently valid switching fabric for communicating data to be further processed, while data being communicated via any one of the other switching fabrics is discarded.

49. The CCU of claim 48, wherein the single exclusively associated one of the switching fabrics is variably selectable in such a way that at any point in time there is only a single currently exclusively associated one of the switching fabrics for each master CE.

50. The CCU of claim 39, wherein each of one or more of the master CEs has two or more of the switching fabrics being exclusively associated with this master CE and configured to variably connect this master CE to one or more of the plurality of interfaces for exchanging thereover information with said CCU-external communication nodes.

51. The CCU of claim 39, wherein each of one or more of the switching fabrics has two or more of the master CEs being exclusively associated with this switching fabric, the switching fabric being configured to variably connect each of these associated master CEs to one or more of the plurality of interfaces for exchanging thereover information with said CCU-external communication nodes.

52. The CCU of claim 38, wherein the CCU further comprises a safety management functionality which is configured to determine a selective allocation of a remaining power which the power supply system can still make available among the computing tasks and/or different components of the CCU, when it is determined that the power the power management system can currently provide is insufficient to properly support all ongoing or imminent already scheduled computing tasks.

53. The CCU of claim 52, wherein the safety management functionality is configured to determine the selective allocation of the remaining power based on the classification information.

54. The CCU of claim 38, wherein the CCU:
is further configured to perform one or more predefined emergency functionalities when its proper functioning is impaired or disrupted; and
comprises an emergency power source being configured to power at least one defined emergency functionality of the CCU, when the power supply system fails to provide sufficient power to support this at least one emergency functionality.

55. The CCU of claim 54, wherein:
the plurality of CEs comprises a group of two or more master CES, which are configured to work redundantly in such a way that they synchronously perform identical computing tasks or data path coordination tasks to enable a proper functioning of the CCU for as long as at least one of the master CEs is properly working; and wherein
one of the switching fabrics is configured as an emergency switching fabric such that:
the emergency power source is configured to power this emergency switching fabric when the power supply system fails to provide sufficient power to support the emergency functionalities; and
the emergency switching fabric is configured to variably connect solely CEs in a true subset of the CEs, the subset including at least one slave CE, to one or more of a plurality of interfaces for exchanging thereover information with CCU-external communication nodes.

56. The CCU of claim 38, wherein at least one of a central fault management functionality and a safety management functionality are implemented redundantly by means of a plurality of respective mutually independent instantiations thereof, wherein each of the master CEs has an associated different one of the instantiations.

57. The CCU of claim 38, wherein at least one of the switching fabrics further comprises for at least one of the interfaces an associated bridge for converting information to be communicated via the respective interface between different communication technologies.

58. The CCU of claim 38, wherein each of the switching fabrics is configured as a PCI Express switching fabric.

59. The CCU of claim 58, wherein at least one of the CEs comprises multiple PCI Express ports, each being communicatively connected to at least one of the switching fabrics being designed as a PCI Express switching fabric.

60. The CCU of claim 59, wherein at least one of the PCI Express switching fabrics comprises a PCI Express interface being operable as a PCI Express non-transparent bridge to enable a communication paths between a first CE being communicatively connected with the PCI Express non-transparent bridge via an associated PCI Express root port of such CE and a second CE being communicatively connected to that PCI Express switching fabric.

61. The CCU of claim 58, wherein the CCU is further configured to perform a boot process or reset process during which the communication nodes connected to the at least one PCI Express switching fabric are fully enumerated such that upon completion of the process, these communication nodes have an assigned identification code by which they can be distinguished by other communication nodes and/or the PCI Express switching fabric itself.

62. The CCU of claim 38, wherein the CCU is configured to operate two or more of the CES according to a same shared clock.

63. The CCU of claim 38, wherein each of the power supply sub-systems individually comprises at least one own power source and a power control arrangement for controlling a supply of power from the at least one own power source to all of the CES and switching fabrics or to at least a subset thereof being associated with the respective power supply sub-system.

64. The CCU of claim 63, wherein the power control arrangement is configured to control the supply of power from the at least one own power source to different subsystems or components of the CCU selectively as a function of an amount of energy the at least one own power source is currently capable of delivering.

65. The CCU of claim 38, further comprising a supply controller being configured:
to determine, based on state information representing for each power supply sub-system its current condition, a distribution of individual power supply contributions to be supplied by the various power supply sub-systems such that these contributions collectively meet a current target power level of the CCU; and
to control the power supply sub-systems to cause each of them to supply power according to its determined respective individual power supply contribution.

66. The CCU of claim 38, wherein the CCU comprises a security functionality being configured to apply one or more of:
encryption or obfuscation to data to be communicated via the switching fabrics;
authentication of at least one device being connected, directly or indirectly, as a communication node to one or more of the switching fabrics; and
security off-loading of security tasks related to the security functionality to specialized security components of the CCU other than the CEs.

67. The CCU of claim 38, wherein:
the CCU is configured to host the CEs in co-location within a same shared housing structure; and
one or more of the CES are incorporated, individually or together with one or more other CEs, in a respective replaceable assembly that is individually insertable and extractable from the housing structure.

68. The CCU of claim 67, wherein the CCU further comprises a service assembly configured to be also hosted in the housing structure, the service assembly comprising at least one of the power supply sub-systems, the switching fabrics, and the interfaces.

69. The CCU of claim 68, wherein the service assembly is configured as a replaceable assembly which is individually insertable and extractable from the housing structure.

70. The CCU of claim 67, wherein the plurality of CEs comprises a group of two or more master CEs, which are configured to work redundantly in such a way that they synchronously perform identical computing tasks or data path coordination tasks to enable a proper functioning of the CCU for as long as at least one of the master CEs is properly working; and wherein two or more of the master CEs are incorporated in a same one of the assemblies.

71. The CCU of claim 70, wherein the housing structure comprises a rack having two or more compartments, each compartment for hosting a respective assembly.

72. The CCU of claim 67, wherein the housing structure further comprises a connection device configured to:
provide one or more physical communication paths of at least one of said communication networks for exchanging messages among the CEs being co-located in the housing structure and each being communicatively connected to the connection device as a respective communication node of said at least one communication network; and/or
connect at least one of the CEs being co-located in the housing structure to the power supply system to enable a power supply of said at least one CE.

73. The CCU of claim 72, wherein the connection device is a passive connection device comprising exclusively components being incapable of power gain.

74. A vehicle, particularly an automobile, comprising the CCU of claim 38, as an on-board computing unit for centrally controlling different functionalities of the vehicle.
